(19) United States
(12) Patent Application Publication
(10) Pub. No.: US 2011/0078628 A1
(43) Pub. Date: Mar. 31, 2011

(54) SYSTEMS AND METHODS FOR USING VIEWERSHIP TO ENHANCE A MEDIA LISTING DISPLAY IN A MEDIA GUIDANCE APPLICATION

(75) Inventor: Scott Rosenberg, Glen Ridge, NJ (US)

(73) Assignee: Rovi Technologies Corporation, Santa Clara, CA (US)

(21) Appl. No.: 12/571,011

(22) Filed: Sep. 30, 2009

(51) Int. Cl. G06F 3/048

(52) U.S. Cl. 715/811

(57) ABSTRACT

Systems and methods are provided for providing listings in a media guidance application based on predicted or real time viewership of a media item. If viewership for a media item is determined to not meet a target viewership, a listing for the media item in the media guidance application is enhanced.

### BACKGROUND OF THE INVENTION

This invention relates generally to media systems, and more particularly, to media guidance applications that provide changes to a media listing display, such as an enhanced listing, using viewership information.

An interactive media guidance application may be used by a user to navigate through various types of media content that may be viewed, accessed or otherwise obtained via one or more user devices or equipment. Some common types of media content include, for example, broadcast television channels, interactive applications (such as interactive games, online education, consumer applications, and others), digital music, on-demand programming (e.g., video on-demand (VOD) programming), Internet resources, recorded content (e.g., content recorded to a local video recorder), or other media content. Such media content may be provided with advertising. Fees for such advertising may be associated with target audience levels and actual viewership of the media content. In addition, some advertising fees may be based on meeting certain audience levels. Accordingly, media providers and distributors may have an incentive to increase viewership of the content. Embodiments of the invention described herein are directed to using a media guidance application to increase viewership of certain media content using predicted viewership and media listing enhancements.

### SUMMARY OF THE INVENTION

In one embodiment, systems and methods for providing media information in a media guidance application are provided in which viewership for a media item is determined. Generally, viewership of the media item may be determined or predicted using real time early indications of viewing, clickstream data information, user selections, third party audience and interest information, as well as information indicating an omission of user selections associated with the media item. A determination may be made as to whether the viewership corresponds to a target viewership. Target viewership information may be a fixed number or some range of target values. Target viewership may be received from or established by a distributor or provider of the media item. In some embodiments, target viewership may be set or determined by other entities, such as an advertiser, and the target viewership may be the basis of advertising fee payments.

If the determined viewership does not correspond to the target viewership, a listing for the media item may be enhanced. For example, the media item listing may be changed from a standard listing to an enhanced listing, such as a listing with rich content. In another approach, enhancements to a media item listing may be applied for certain viewers who may be identified, for example, as likely to be interested in the media item.

In some embodiments, following the enhancement of the media item listing, viewership may be determined again. This second viewership determination may be used to determine whether the listing enhancement had an effect on predicted or actual viewership. For example, the second viewership determination may indicate an increase or decrease, which may be associated with the use of an enhanced listing. In addition, the second viewership determinations may be performed in order to determine whether any further changes to a media item listing may be necessary. For example, if the second viewership is determined to correspond to the target viewership, the enhanced listing may be changed back to a standard listing. Alternatively, if the second viewership prediction does not correspond to the target viewership, some additional changes to the listing may be made, such as additional enhancements, including, for example, advertising elements, larger graphics, or other enhancements. Viewership monitoring may continue on a periodic basis to determine whether listing changes may be useful for improving viewership.

In another embodiment listings of media items may be enhanced by selection of certain media items. The media items may be selected for enhancements based on a priority scheme. The priority scheme may include one or more combinations of weighted factors including: media item type, time to availability of the media item, user preferences, history of enhanced listings, display arrangement, or other factor.

In another embodiment, viewership information may be used as a basis for providing additional media guidance application options or features, such as targeted advertising within the display of the media guidance application, providing links to trailers or samples of media content, and promotional discounts.

In another embodiment, increases in actual viewership of a media item following a listing enhancement compared to predicted or past viewership may be a basis for advertising revenue sharing.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1-2 show illustrative display screens that may be used to provide media guidance application listings in accordance with one embodiment of the invention;

FIG. 3 shows an illustrative user equipment device in accordance with one embodiment of the invention;

FIG. 4 is a simplified diagram of an illustrative interactive media system in accordance with one embodiment of the invention; and

FIGS. 5-8 show illustrative processes in accordance with embodiments of the invention.

### DETAILED DESCRIPTION OF EMBODIMENTS

The amount of media available to users in any given media delivery system can be substantial. Consequently, many users are often faced with difficulties in identifying media of interest. In addition, media providers and distributors are increasingly challenged with emphasizing and promoting media items to viewers who are inundated with media choices. An interactive media guidance application, as described herein, provides improvements over conventional systems by using viewership information, including viewership predictions to emphasize certain media items using enhanced listings and enhanced listing displays. In general, an interactive media guidance application provides media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc. Guidance applications also allow users to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but can also be part of a live performance. It should be understood that the invention embodiments that are discussed in relation to media content are also applicable to other types of content, such as video, audio and/or multimedia.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices, users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

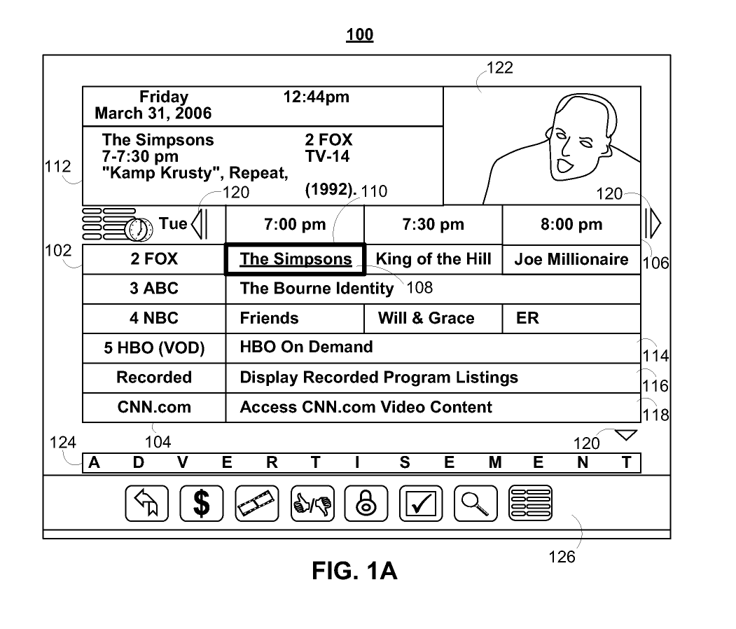

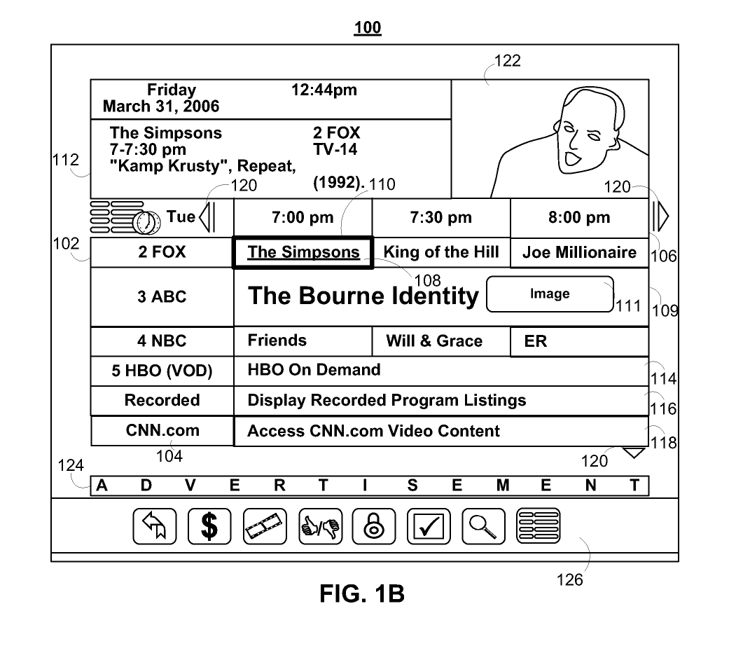

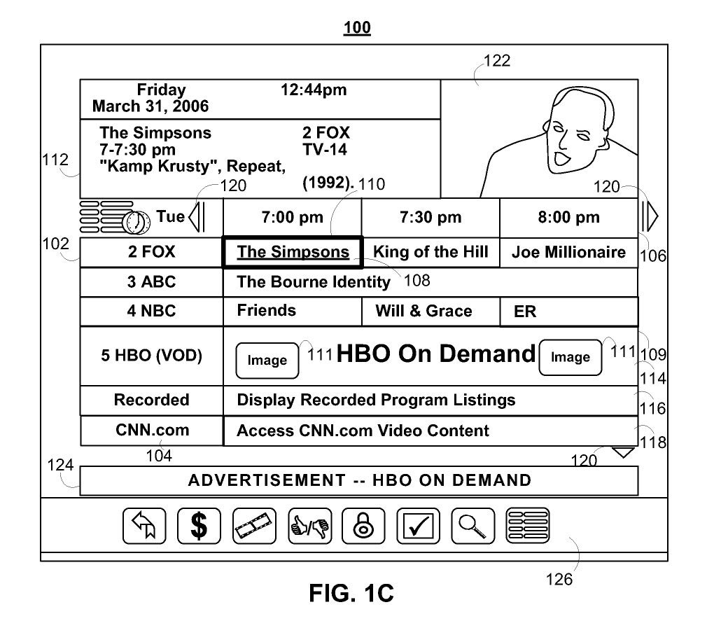

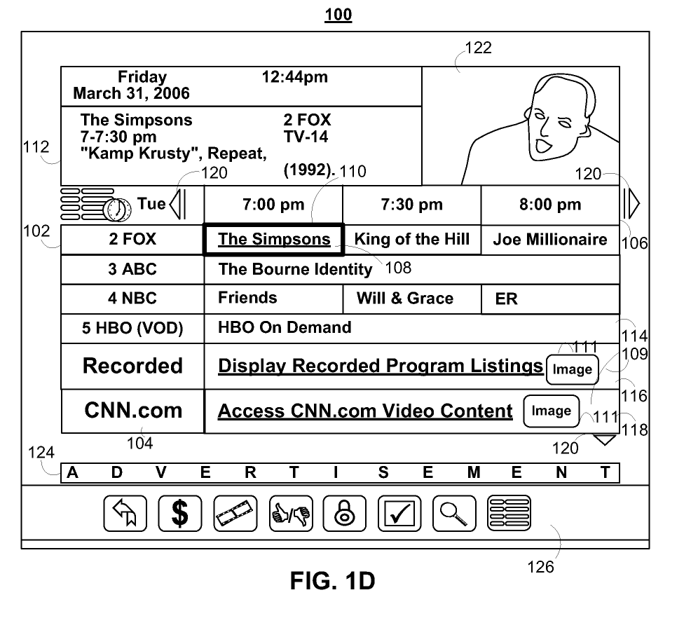

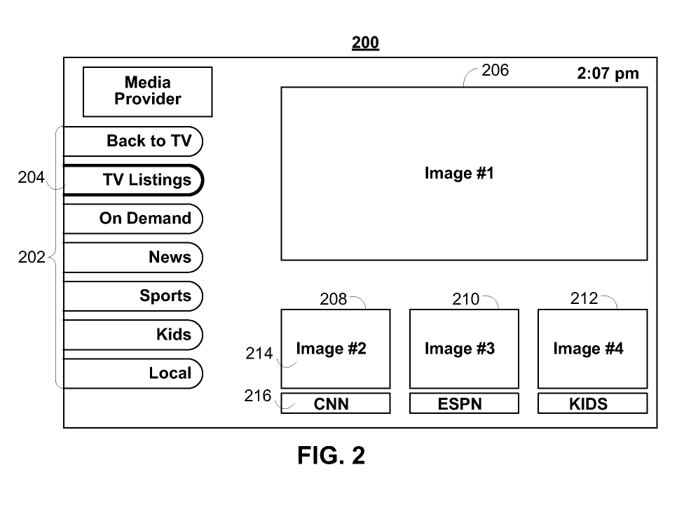

One of the functions of the media guidance application is to provide media listings and media information to users. FIGS. 1-2 show illustrative display screens that may be used to provide media guidance, and in particular media listings. The display screens shown in FIGS. 1-2 may be implemented on any suitable device or platform. While the displays of FIGS. 1-2 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's selection, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1A shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. Program listing 108 may be considered a default standard style listing. Variations of such listings 108 may also be provided in other forms, such as enhanced listings, as described herein. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g. FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, Schein et al. U.S. Pat. No. 6,388,714, issued May 14, 2002, and Rosenberg et al., U.S. patent application filed Sep. 30, 2009 titled “SYSTEMS AND METHODS FOR AUTOMATICALLY GENERATING ADVERTISEMENTS USING A MEDIA GUIDANCE APPLICATION,” attorney docket no. UV-501, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Use of such features may be used as a basis for predicting likely viewership or use of a media item. For example, a user setting a reminder for a media item may be an indication that a user is interested in the item. In another example, a user may select a favorites option for a media item, which may also be an indication that the user is interested in the item and likely to watch it. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, enhanced listing wraps, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

In another arrangement, the display shown in FIG. 1B may includes variations of listing formats, such as an enhanced listing 109. The enhanced listing 109 may have one or more types or combinations of enhancements including rich content, such as a graphical element, link to additional content, image 111, and in addition, varied font sizes and types, that may increase visibility of a particular listing. The term enhanced listing is meant to refer to any type of listing that is different than a standard listing and includes enhancements such as graphics, image, links, and rich content, in any combination, so that the enhanced listing deviates in form from other listings presented with the enhanced listing. An enhanced listing 109 may be presented in a display 100 to differentiate the enhanced listing 109 from other listings 108, 114, 116, 118. In some embodiments, use of enhanced listing 109 is provided to highlight a particular media item, for example, to increase viewership of the item. The use of enhanced listings 109 may be continuous for a particular media item. In some scenarios, the enhanced listing 109 may return to an original standard form, such as shown in FIG. 1A. Enhanced listing formats may be used to temporarily increase visibility of an item, or used for an extended or permanent period. Use of the enhanced listing format may be tied to a determination, further described herein, of viewership of the media item in comparison with a target viewership for the media item. As would be understood by one of skill in the art, the methods described herein may be applied in other scenarios for highlighting certain media items.

In another display arrangement depicted in FIG. 1C, a VOD channel is shown with an enhanced listing 109 that may include one or more images 111 or other rich content. The enhanced listing for a VOD item, or other item, may be for a specific media item, service, series of media content, such as the VOD service, other VOD programming, and a series of VOD content. Another aspect of an enhanced listing display may include additional targeted advertising 124 that may be associated with the enhanced listing 109 to further highlight the media item. Combinations of listing elements and advertisements may be used to create one or more distinctive enhanced listings for a media item. Enhanced listings may also be personalized for a particular viewer or viewer type using user profile and preference information to provide a listing that may appeal to the individual.

FIG. 1D depicts another display arrangement in which two listings are shown with expanded or enhanced listings 109. As shown in FIG. 1D, online and recorded content may also be displayed in an enhanced listing, e.g., displayed with a larger listing format, and may also include selectable links to the content, or recorded content, as well as to other associated content. Images 111, rich content or other graphical elements may also be used with enhanced listings 109. As can be seen in FIG. 1D, providing two adjacent media items in an enhanced listing format may not provide the same visibility as for one highlighted item, as shown in FIGS. 1B-C. Thus, some prioritization and selection may be used to identify one or more limited media items for enhanced listings in order to maintain a user's focus on the enhanced listing.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on). Listings may also be enhanced using full screen graphical wraps (not shown) so that a media guidance application screen is filled with listing related graphics.

The listings in display 200 are of different sizes (i.e., listing 206 is larger than listings 208, 210, and 212), but if desired, all the listings may be the same size or other variations of sizes. Listings may be of different sizes or graphically accentuated to indicate degrees of interest to the user or to emphasize certain content, as desired by the media provider or based on user preferences or user profiles. For example, a large size, graphically accentuated or an otherwise enhanced listing 206 may be provided to emphasize certain content that, for example, may have predicted or actual viewership that may not meet an expected or target audience. Providing the large or enhanced listing may be used to highlight one media item listing 206 over other listings 208-212, for example to increase visibility of and interest in the media item. Listings 208-212 may also have been selected as secondary media items to highlight over other media items (not shown). The selection of more than one media item for an enhanced listing display may involve one or more priority criteria, further described herein.

Various systems and methods for graphically accentuating media listings are discussed in, for example, Yates, U.S. patent application Ser. No. 11/324,202, filed Dec. 29, 2005, which is hereby incorporated by reference herein in its entirety.

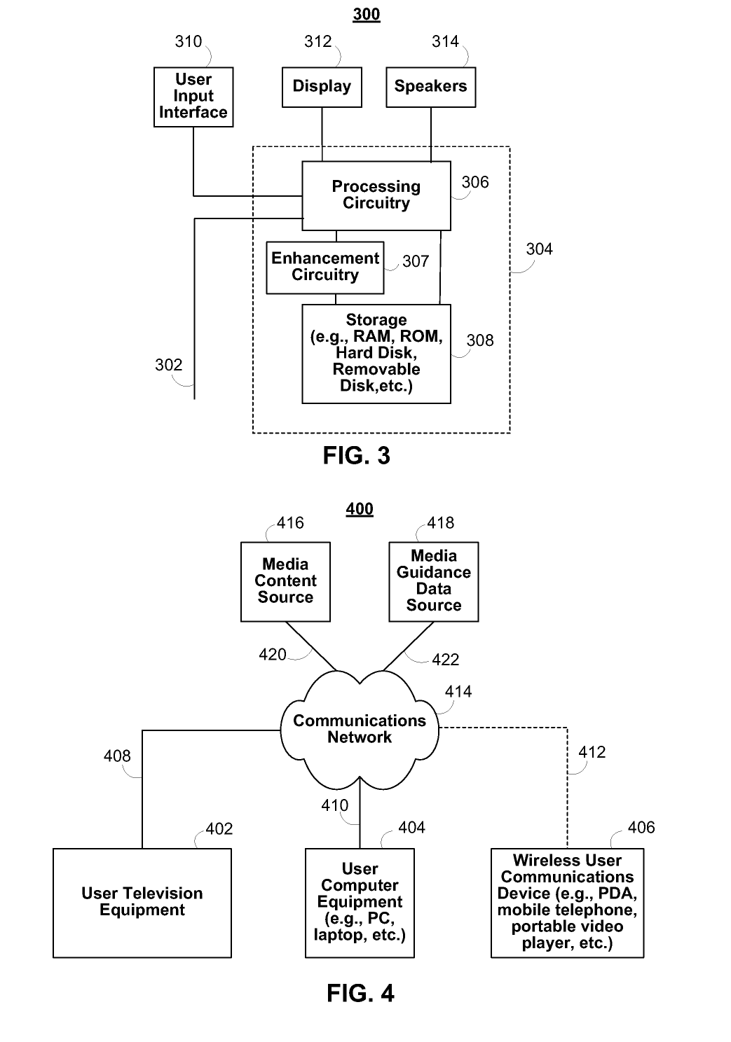

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 3. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306, enhancement circuitry 307, and storage 308. Control circuitry 304 may be used to send and receive commands, requests, and other suitable data using I/O path 302. I/O path 302 may connect control circuitry 304 (and specifically processing circuitry 306 and enhancement circuitry 307) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 and enhancement circuitry 307 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, enhanced listing information, enhanced advertising information, enhanced display arrangements, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In addition, information indicating application use may be stored locally and uploaded on a periodic basis (e.g., from the VBI of a television channel, from an out-of-band feed, or using another suitable approach). For example, user selections relating to media items may be stored locally and periodically uploaded for analysis, such as viewership predictions. Local analysis of the user selections may also be performed using control circuitry 304. In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. In such an embodiment, user information and user selections relating to media items may be transmitted to the remote server for analysis and viewer predicting calculations.

In yet other embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be a EBIF widget. In other embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program. In such embodiments, the control circuitry 304 may also control storage of user selections associated with media items and analysis of the same.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, enhanced media listings, enhanced media associated advertising, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel).

Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

The various embodiments of the media guidance application are configured to, among other things, provide a user with an interface for accessing media items. When a user uses the media guidance application to identify, locate, navigate among, and access media item, the key strokes entered, options selected, and other user selections made, for example using user input interface 310 or user equipment 404, communications device 406 may be recorded and analyzed. These user selections may be stored locally in storage 308 for processing by control circuitry 304, uploaded to remote servers for storage and analysis, or some combination of local and remote storage and processing. In general, information indicating user selections may be useful for media content providers and guidance application providers to determine the media items, features and functions that are useful and interesting to users. Such user selections may be types of clickstream data that may be collected by the media guidance application for local use and/or uploaded to a headend or remote server for processing. Some examples of clickstream data relevant for predicting viewership for future programming may include data indicating that users have selected to view program information about a program or schedule information for advance programming, set reminders for an upcoming program, purchased an upcoming program, subscribed to a channel for the upcoming program, or other suitable information. User selections for current programming may also be useful for providing real time actual early indications of viewership.

For viewership predictions, certain types of clickstream data may indicate a greater likelihood that a user will view a media item. For example, purchasing an upcoming program and setting a reminder for a media item may indicate a high likelihood that a user will view a media item. Accordingly a higher weight may be assigned to such user selections. Other types of clickstream data, such as data indicating that a user has viewed program information or schedule information for a program may indicate general interest, and may be assigned a relatively lower weight for likelihood of media use. If clickstream data indicates that users are not selecting or have not selected program or schedule information for a media item, such clickstream data can be an indication that a viewer is not likely to view a media item. The timing of user selections may also be indicative of likelihood of viewership. For example, a user setting a reminder very far in advance of or close in time to a media items availability may indicate high interest. Combinations of user selections may also indicate a high likelihood of viewership. For example, viewing program information, setting a reminder for a media item, and selecting a character in the media item as a favorite may also indicate a high likelihood of viewership. As will be understood by one of skill in the art, certain combinations and omissions of user selections may be used to predict viewership or use of a media item.

Individual or aggregated user selections may be used for viewership predictions. On an aggregated basis, which may be an aggregation of user selection data from all devices, or some subset of user selections that may be received and processed at a remote server or headend facility, user selections may be used to predict audience or viewership for a media item and provide early indications of viewership for a media item. Audience and viewership predictions may also be based on past actual audience levels which may be obtained from a third party or using aggregated data processed at a remote server or headend facility. Audience predictions and early indications of viewership may be useful in various scenarios, including, for example, for advertising sales. A media content provider or source may sell advertisements based on actual or expected viewers. For some advertisements, the media provider, typically the advertisement seller, may promise a certain audience or viewership for the media item to an advertisement buyer. For other advertisements, an advertisement sale price, frequency or duration may be tied to viewership. Accordingly, a media content provider may have some incentive to attract viewers and boost viewership of a particular media item in order to meet advertising goals. One way to boost viewership of a media item may be to provide special or enhanced listing displays in the media guidance application so that a viewer's attention is drawn to the listing. A media guidance application provider may provide listings enhancement to increase audiences and share the increased advertising revenue with the media content provider or distributor. Examples of enhanced listing displays have been previously discussed in connection with FIGS. 1B-2. Enhanced listings may be any type of media item program listing or advertising element that is different or distinguished from other listings so that the enhanced listing stands out in a display of listings in a media guidance application. In addition, advertising elements may also be incorporated in an enhanced listing display to further emphasize a particular media item, as described in Rosenberg et al., U.S. patent application filed Sep. 30, 2009 titled “SYSTEMS AND METHODS FOR AUTOMATICALLY GENERATING ADVERTISEMENTS USING A MEDIA GUIDANCE APPLICATION,” attorney docket no. UV-501, which is incorporated by reference herein in its entirety. Other options and features may also be provided in the listing display to emphasize a media item, such as promotional samples, trailers, discounted access, etc. As discussed previously, one or more media items may be selected and provided with an enhanced listing. The one or more media items may be selected to have an enhanced listing or listing display based on a priority scheme.

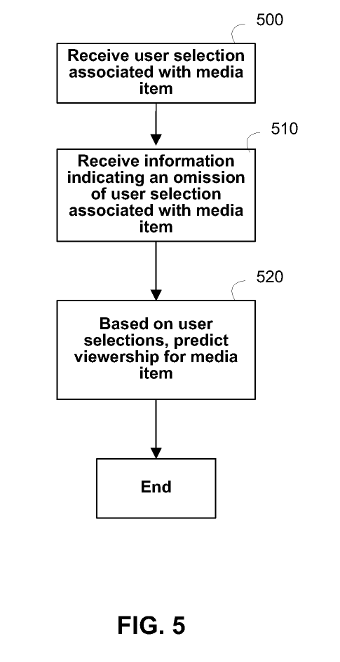

In embodiments of the invention, viewership prediction may be performed to determine whether viewership of a media item corresponds to viewership targets for the media item. FIG. 5 provides one process for predicting viewership of a media item. At step 500, user selections associated with a media item may be received. In general, user selections (including individual user selections, aggregated user selections or a subset of users selections) associated with a media item are entered via a user input interface 310, user computer equipment 404, wireless communications device 406, or other suitable interface. The user selections may be stored locally in storage 308 or in a combination of local and remote locations. The user selections may be any individual or combinations of selections in the media guidance application that may be associated with a media item. For example, user selections may be any of the options 126 for a media item, such as setting a reminder, favorites settings, enabling recording of a program, purchasing a program, viewing program information, or other user selection. Information indicating omissions of user selections may also be received at step 510. Omission information is typically obtained by determining whether certain media items have not had any user selections. The user selection information and omission of user selection information may be used at step 520 to predict viewership for the associated media item. Viewership prediction may be performed using control circuitry 304 or at a remote server, headend, or combination of processing facilities. Viewership prediction is generally discussed in application Ser. No. 09/823,705 filed Mar. 30, 2001, U.S. Patent Publication No.: 20020056087, attorney docket number UV-193, which is incorporated by reference in its entirety. User selections and monitoring are discussed in application Ser. No. 10/953,487 filed Sep. 29, 2004, U.S. Patent Publication No.: 20050149964, attorney docket number UV-57, which is incorporated by reference in its entirety.

The received user selection information and omission of user selection information may be used for individual viewers as well as aggregated from multiple viewers. User selections and omissions of user selections may have various weights relating to likelihood of viewing that may be used in the viewership prediction. In addition, combinations of user selections and omissions may also have various weights. For example, a user selection for setting a reminder for a media item and setting a future recording may have a higher weight than a user selection for viewing program information. In another example, setting a reminder far in advance of an availability time in combination with setting a character in the media item as a favorite may have a higher weight than setting a reminder shortly before the media item becomes available. Other weighting, algorithms, and combinations may also be used.

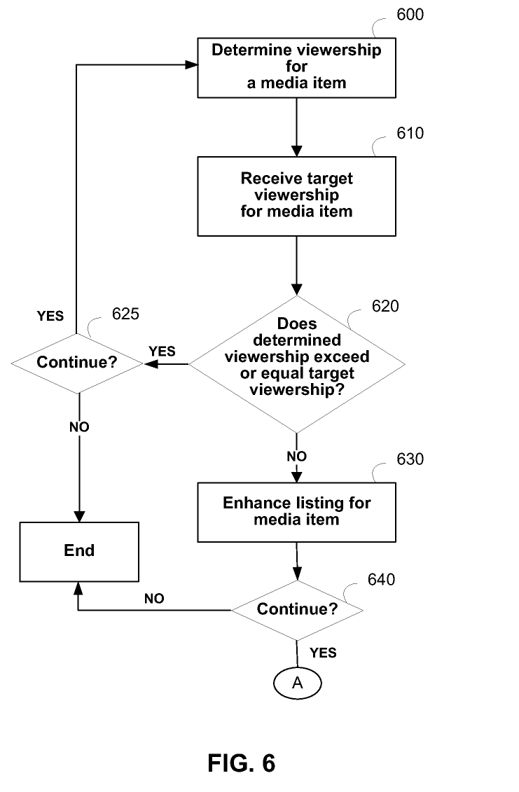

Turning to FIG. 6, in some embodiments the viewership prediction discussed in connection with FIG. 5 may be used at step 600 in a process for enhancing listings for a media item in a media guidance application. At step 600 viewership is determined for a certain media item. In some embodiments, the viewership determination may be based on a prediction as discussed with reference to FIG. 5. In other embodiments, viewership determinations may be based on information provided by external sources, such as a third party, media provider, online sources, or other source. In some embodiments, viewership determinations may be based in part on past actual audience information. In another embodiment, viewership determinations are based on actual early indications of viewership of a media item. Early indications of viewership of a media item may be based on real time user selections of a particular media item. Such user selections of a media item may be entered via user input 310, user equipment 404 or devices 406, and data indicating such selections may be stored locally in control circuitry 304 or transmitted to a remote server or headend for aggregation. Representative sub sets of user selections of a media item may be used to extrapolate early viewership of a media item. In other embodiments, viewership determinations may be based on prior broadcasts of a media item, or prior broadcasts of an earlier episode in a series.

A target viewership for the media item may be received at step 610. The target viewership is typically a fixed value or range of values that may be set for a goal audience for the media item. For example, the target viewership may be a range of audience numbers, each of which may be connected to a certain advertising fee. The target viewership may also be a value associated with advertising for the media item, for example, the target viewership may be an audience number promised to an advertiser. The determined viewership and target viewership may be compared at step 620 to determine whether the target and determined viewerships correspond. In the event that the determined viewership is equal to or greater than the target viewership, no changes for a media item listing may be necessary. A decision may be made at step 625 whether continue monitoring viewership. Such a decision may be performed by enhancement circuitry 307, control circuitry 304 or a remote processing facility. The decision to continue monitoring viewership may be based on a priority for the media item, or other factor. Continuing monitoring viewership of the media item may cause the process to return to step 600 and provide continuous ongoing viewership determinations. If the decision is to not continue monitoring of viewership, the process may end.

In the event that the predicted viewership is determined at step 620 to be less than the target viewership, a listing for the media item may be changed at step 630. In general, changing a media item listing may be provided by the control circuitry 304 and enhancement circuitry 307. Control circuitry 304 or enhancement circuitry 307 will obtain enhancement listing information from storage 308 or other remote storage and transmit the enhancement data for display in the media guidance application for the listing to be changed or enhanced. Some examples of enhanced listings are shown in FIGS. 1B-2. The enhanced listings are meant to highlight a particular media item over listings for other media items as discussed previously. The change to the enhanced listing may be temporary or permanent, depending on the duration of a listing, and a determined need to continue highlighting a particular media item. In some embodiments, changes to listings may occur globally for all media guidance applications, or be limited to a local media guidance application, or certain identified users who may be interested in the media item.

Following the enhancement of the media item at step 630, a decision may be made to continue the enhancement of the listing at step 640. The decision at step 640 may be performed by enhancement circuitry 307, control circuitry, or at a remote server, or combination thereof. The decision may be based on one or more factors associated with the enhanced listing, including, for example, a determination of a relative success of the enhancement, duration of the enhanced listing, time of enhanced listing as compared to the availability time of the media item, improvements in viewership, or other factor. In addition, a determination may be made as to whether a different type of enhanced listing may be appropriate. For example, different types of rich content may be added or substituted in the enhanced listing. In addition, features and options may be provided in the enhanced listing, such as trailers, promotions and advertisements.

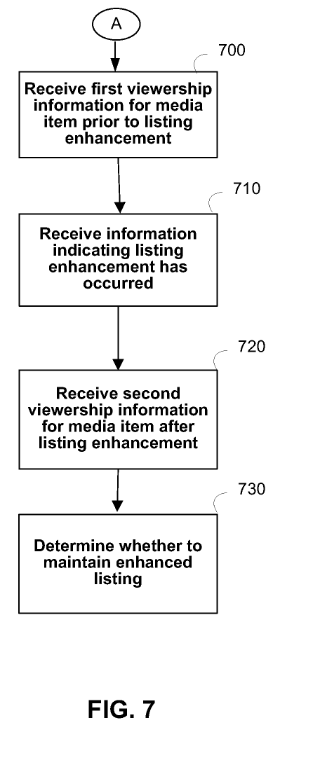

If the enhancement of the listing is not continued, the process may end. If the enhancement of the listing is continued, the process may continue to the monitoring process depicted in FIG. 7. By continuing to monitor the enhanced listing, the media guidance application can track later user selections and recalculate viewership predictions and determine whether they have improved following the enhancements to the listing.

Embodiments of the media guidance application are designed to continue monitoring user selections to provide real time viewership predictions and dynamically enhance listings as necessary. Information relating to the viewership predictions and listing changes may be shared with third parties, such as the media provider, for advertising revenue sharing and supporting advertising optimization.

Listing changes may be monitored to determine whether the listing change has any effect on improving viewership. Turning to FIG. 7, first viewership information may be received at step 700. Such viewership information may be a viewership prediction, an early indication of viewership, viewership number provided by a third party, or other viewership information. The first viewership information is generally provided before a media item listing is changed, i.e., prior to an enhanced listing or enhanced listing display is provided. The first viewership information received at step 700 may be generated locally by enhancement circuitry 307 or control circuitry 304, or received by control circuitry 304 from a remote server, third party or other source.

Information indicating that such enhancement has occurred may be received at step 710. In some embodiments, control circuitry 304 and enhancement circuitry 307 may flag enhancements as they are implemented in a media guidance display. In other embodiments, data indicating the enhancement information may be transmitted from a remote server or headend to local or remote processing that includes, for example, a time, period, type of enhancement, and other data related to the enhancement.

Following the enhanced listing occurrence, second viewership may be determined at step 720. The second viewership may be provided according to the prediction process described with reference to FIG. 5. Alternatively, second viewership may be provided by early audience indications or real time information as determined by control circuitry 304. In some embodiments, first and second viewership determinations may be provided for serial programming, meaning that the first viewership determination is for one episode and the second viewership determination is for a second episode that follows an enhanced listing for the media item. In some embodiments, the first and second viewership determinations are performed for a single media item prior to its broadcast or availability. In other embodiments, first and second viewership determinations may be provided for a first broadcast and secondary rebroadcast of the same media item. Similarly, first and second viewership determinations may be provided for first airings and VOD offerings for a media item.

A comparison of the first and second viewership determinations may be performed to determine whether the enhanced listing should be maintained at step 730. Such comparison may be performed by control circuitry 304, user equipment 404, remote server, headend facility, etc. Improvement of the second viewership determination over the first viewership determination may indicate that the changed listing may have drawn additional viewers. Such information may be shared among advertising partners, media content providers and other parties for revenue sharing purposes, future guide display planning, and other uses. In some scenarios, the enhanced listing may be maintained when second viewership determinations show improvement over first viewership determinations, for example, to continue to drive increases in viewers. In other scenarios, the enhanced listing may be removed if viewership improves. In yet another scenario, other types of listing enhancements, features or options may be provided to improve viewership predictions. Various factors may be used to determine whether to maintain or end an enhanced listing, such as time, viewership improvements, user preferences, and other factors.

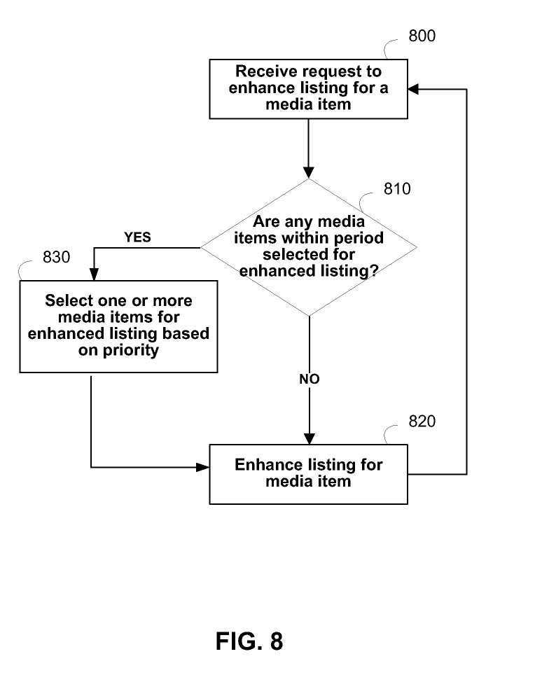

In some embodiments, maintaining or ending an enhanced listing may be manually decided or executed based on meeting certain criteria, such as viewership values. In other embodiments, the selection of one or more media items for an enhanced listing display may be provided according to the process of FIG. 8. As shown, a request to enhance a listing for a media item may be received at step 800. Such a request may be received by control circuitry 304, enhancement circuitry 307, or at a remote server or headend facility. The request may be triggered by certain criteria. For example, an enhanced listing may be requested for a media item that has lower than target viewership (see FIG. 6), a media item that a network has identified for certain promotions, or a media item that a media guidance application provider has identified for advertising revenue sharing based on increasing viewership. The enhancement circuitry 307 (or remote analog) may perform one or more checks before rendering an enhanced listing display. For example, the enhancement circuitry 307 may check whether other media items are selected for enhanced listing display at step 810. As shown in FIG. 1D, although two (or more) media items may be shown with an enhanced listing format, the number of media items to be highlighted or enhanced may be limited to ensure that the display is not overcrowded with enhanced listings. Otherwise, the selected media item's enhanced listing would not stand out against other media items' enhanced listings. In FIG. 2, four media items are represented in the enhanced listing display with one 206 featured larger than the other three 208, 210 and 212. For the display arrangement of FIG. 2, no more than four media items may be selected for enhancements. Of course, other display styles may be used with various limits for the number of displayed media items. In general, if no other media items are selected for an enhanced listing display, the requested media item listing may be changed at step 820. If other media items are selected for enhanced listings within a period, the media items may be selected according to a priority scheme at step 830.

Priority schemes for selecting media items for enhanced listing displays may vary, for example, based on user preferences, network preferences, system frameworks, and display arrangements. For example, in the display arrangement depicted in FIG. 2, four media items may be selected for enhanced listings. In such an arrangement, a relevant priority scheme could focus the media item selection to the number of items that can be displayed in the format. For a display arrangement as shown in FIGS. 1B and 1C, a single media item is selected for an enhanced listing and related advertising may be displayed to further enhance the display.

A type of media item may also be a basis for prioritized selection. For example, new to-be-released items, serial content, and on demand items may have a higher priority than, for example, re-broadcasts, recordings, or ongoing online content. In addition, media providers and advertisement providers may also indicate that a certain prioritization scheme be used to prioritize certain types of media content, content available at certain times, or other scheme. Accordingly, if a request for enhanced listings are received for re-broadcasted episodes, such request may be postponed in favor of a new to broadcast episode, an on demand media item, or some media item of a high priority as established by a media provider.

The priority scheme for selecting a media item for enhanced listing may also include a time element. For example, a media item that will be aired or available in a short time may have a higher priority than a similar media item having a broadcast time at a later date.

Another aspect of the priority scheme may be a determination of whether the media item has been previously selected for an enhanced listing. Information indicating the effectiveness of the use of the enhanced listing (see FIG. 7) may also be relevant in the selection. Although repetitive listings may be highly effective, they may also contribute to viewer display fatigue.

Priority schemes for selecting the media item may also include user preferences, based on both user-entered preferences, and detected preferences based on monitored user history. For example, for a viewer that has selected a certain favorite actor, media items including such favorite actor may be selected for an enhanced listing. As will be understood by one of skill in the art, one or more priority schemes may be used with varying combinations of factors for selection of a media item for an enhanced listing display.

The above described embodiments of the present invention are presented for purposes of illustration and not of limitation, and the present invention is limited only by the claims which follow.

What is claimed is:

1. A method for providing a listings display in a media guidance application, the method comprising:
providing a display of listings of media items comprising a plurality of selectable options associated with each of the media items;
receiving a user selection associated with one of the media items;
determining a viewership for the media item, based at least in part on the received user selections;
receiving a target viewership for the media item;
determining whether the determined viewership for the media item corresponds to a target viewership; and
if the determined viewership of the media item does not correspond to the target viewership; using enhancement circuitry to enhance a listing for the media item.

2. The method of claim 1 wherein the enhancement circuitry enhances the listing for the media item by providing at least one of the group of: rich content, graphical element, and advertisement.

3. The method of claim 1 further comprising after the listing for the media item has been enhanced, determining a second viewership of the media item.

4. The method of claim 1 further comprising identifying potential viewers of the media item; and enhancing the listing for the media item for the identified potential viewer.

5. The method of claim 1 wherein determining a viewership for the media item is based in part on an omission of a user selection associated with the media item.

6. The method of claim 1 wherein predicting a viewership for the media item is based in part on a user selection associated with the media item.

7. The method of claim 1 wherein the target viewership is received from a media item provider.

8. The method of claim 1 wherein the target viewership is received from a media item distributor.

9. The method of claim 1 further comprising determining an actual viewership of the media item having the enhanced listing; and calculating an increase in the actual viewership and the determined viewership.

10. A system comprising user equipment for implementing an interactive media guidance application, the user equipment operative to:
provide a display of listings of media items comprising a plurality of selectable options associated with each of the media items;
receive a user selection associated with one of the media items;
based at least in part on the received user selections; determine a viewership for the media item;
receive a target viewership for the media item;
determine whether the determined viewership for the media item corresponds to a target viewership; and
if the determined viewership of the media item does not correspond to the target viewership; using enhancement circuitry coupled to the user equipment to enhance a listing for the media item.

11. The system of claim 10 wherein the enhancement circuitry enhances the listing for the media item by providing at least one of the group of: rich content, graphical element, and advertisement

12. The system of claim 10 wherein the user equipment is further operative to after the listing for the media item has been enhanced, determine a second viewership of the media item.

13. The system of claim 10 wherein the user equipment is further operative identify potential viewers of the media item; and change the listing for the media item for the identified potential viewer.

14. The system of claim 10 wherein the user equipment operative predict the viewership for the media item predicts the viewership based in part on at least a user selection.

15. The system of claim 10 wherein the user equipment operative predict the viewership for the media item predicts the viewership for the media item is based in part on an omission of a user selection associated with the media item.

16. The system of claim 10 wherein the user equipment operative predict the viewership for the media item predicts the viewership for the media item is based in part on a user selection associated with the media item.

17. The system of claim 10 wherein the target viewership is received from a media item provider.

18. The system of claim 10 wherein the target viewership is received from a media item distributor.

19. The system of claim 10 wherein the user equipment is further operative to determine an actual viewership of the media item having the enhanced listing; and calculate an increase in the actual viewership and the determined viewership.

20. A method for providing listings in a media guidance application, the method comprising:
providing a display of listings of media items comprising a plurality of selectable options associated with each of the media items;
receiving a request to enhance a listing for a media item;
determining if another request to change a listing for another media item is received;
selecting the media item for an enhanced listing based on a priority scheme; and
transmitting a signal to control generation of an enhanced display including an enhanced listing for the selected media item.

21. The method of claim 20 wherein the priority scheme is based on at least two of the factors of the group of: media item type, time to availability of the media item, user preferences, history of enhanced listings, and display arrangement.

22. A system comprising user equipment for implementing an interactive media guidance application, the user equipment operative to:
provide a display of listings of media items comprising a plurality of selectable options associated with each of the media items;
receive a request to enhance a listing for a media item;
determine if another request to enhance a listing for another media item is received;
select the media item for an enhanced listing based on a priority scheme; and
transmit a signal to control generation of an enhanced display including an enhanced listing for the selected media item.

23. The system of claim 22 wherein the priority scheme is based on at least two of the factors of the group of: media item type, time to availability of the media item, user preferences, history of enhanced listings, and display arrangement.
